(19) United States
(12) Patent Application Publication
(10) Pub. No.: US 2022/0133081 A1
(43) Pub. Date: May 5, 2022

(54) Combination Grill and Container

(71) Applicants: Robert Marsh, Kansas City, MO (US); Heidi Nowotny, Kansas City, MO (US)

(72) Inventors: Robert Marsh, Kansas City, MO (US); Heidi Nowotny, Kansas City, MO (US)

(21) Appl. No.: 17/512,397

(22) Filed: Oct. 27, 2021

Related U.S. Application Data
(60) Provisional application No. 63/107,032, filed on Oct. 29, 2020.

(51) Int. Cl. A47J 33/00

(52) U.S. Cl. CPC A47J 33/00; B65D 25/32

(57) ABSTRACT

A grill with legs for use over an open fire combined with a container having corresponding dimensions for convenient transportation of the grill in an inverted position. The configuration of the grill in the container is designed to maximize the space remining available in the container above the inverted grill for storage and transportation of other items.

### BACKGROUND OF THE INVENTION

This invention relates to a portable grill for use over an open fire, and more particularly, to a combination grill and container for storing the grill. It is desirable for a grill used over an open fire to be reasonably portable, and many prior art grills are designed to fold or collapse to simplify transportation. Unfortunately, these foldable or collapsible grills are often unstable and may collapse when being used over a fire. Grills with legs rigidly attached are more stable, but tend to be bulky and difficult to transport.

Sometimes a grill without legs is utilized, and in use is supported on rocks or other separate structure to elevate it over the open fire. Such structure is likely unavailable in a natural setting, however, and rarely both stable and a suitable height, often creating a hazardous and unstable situation.

It is rarely feasible to transport grills, with or without legs, in a container. Without a suitable container enclosing the grill, the food and fire residue on the grill will get adjacent items dirty during transportation.

### BRIEF SUMMARY OF THE INVENTION

The present invention comprises a grill with legs for use over an open fire combined with a container having corresponding dimensions for convenient transportation of the grill in an inverted position. The configuration of the grill in the container is designed to maximize the space remining available in the container for storage of other items, such as firewood, supplies, food, etc. The unique combination of this invention allows convenient and compact transportation of the rigid grill, while also providing container space for transporting both the grill and a substantial volume of other items. Optionally, a divider with a corresponding shape may be used on top of the inverted grill to provide a barrier between the grill and any other items that might be carried in the container.

### BRIEF DESCRIPTION OF THE SEVERAL VIEWS OF THE DRAWINGS

FIG. 1 shows a perspective view of the grill of the invention.

FIG. 2 shows a side view of the grill of the invention inside the container of the invention.

FIG. 3 shows a top view of the container with the grill inverted in it.

FIG. 4 shows a top view of the container of the invention with the protective divider in place inside it.

### DETAILED DESCRIPTION OF THE INVENTION

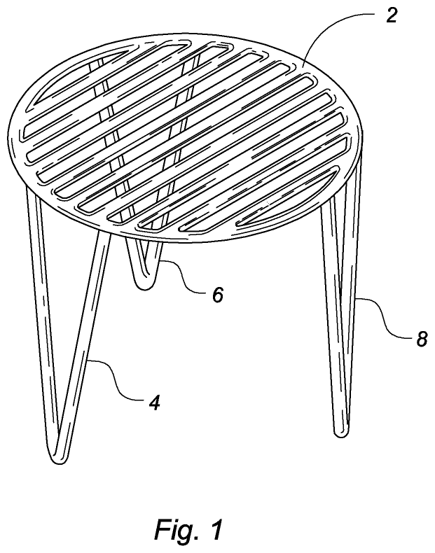

FIG. 1 shows the grill element of the present invention. Sizing of the grill (as well as the container) is important, since an overly large grill and container would consume too much space, and an overly small grill would not be usable. A circular grill shape is preferred, but other shapes, including square, hexagonal and octagonal could also be suitable. The preferred size for a circular grill in this invention is between 9 and 15 inches in diameter (and more preferably 9 to 12 inches in diameter) and stands at a height of between 8 and 14 inches. The container would have the same shape as the grill, again preferably circular, and with a diameter slightly larger than the diameter of the grill, as discussed in more detail below. Alternatively, the container could have a circular shape even if the grill shape is not circular. The container height should be at least the height of the grill standing on its legs, preferably at least 2 inches, and more preferably at least 4 inches, higher than the standing grill.

As shown in FIG. 1, a circular grill 2 having a diameter in the preferred range includes three legs 4, 6, and 8. At least three legs are necessary, but four legs or more would also be suitable. Three legs are preferred to minimize the weight of the grill. The legs are preferably permanently attached to the grill in a rigid position, with no unfolding and other leg movement, assembly or attachment required. The legs may extend perpendicular to said grill (with the leg and grill forming a 90 degree “grill leg angle”), or the grill leg angle may be more or less than 90 degrees (if more than 90 degrees, the legs would extend outward from a cylinder defined by the circular grill). Preferably the grill leg angle is between 90 degrees and 120 degrees. The legs may include additional structure, but for purposes of calculating the leg angle, the plane of the grill is compared with the line from the point where the leg contacts the ground when the grill is in use to the outer diameter of the grill. The legs should be located at the perimeter of the grill, and with the structure of the legs preferably falling within a relatively narrow cylindrical ring passing through the perimeter of the grill (or, in the case of a grill leg angle greater than 90 degrees, the conical ring coinciding with the outward angle of the legs). This leg structure is important to maximize the volume of the gear storage cylinder described below.

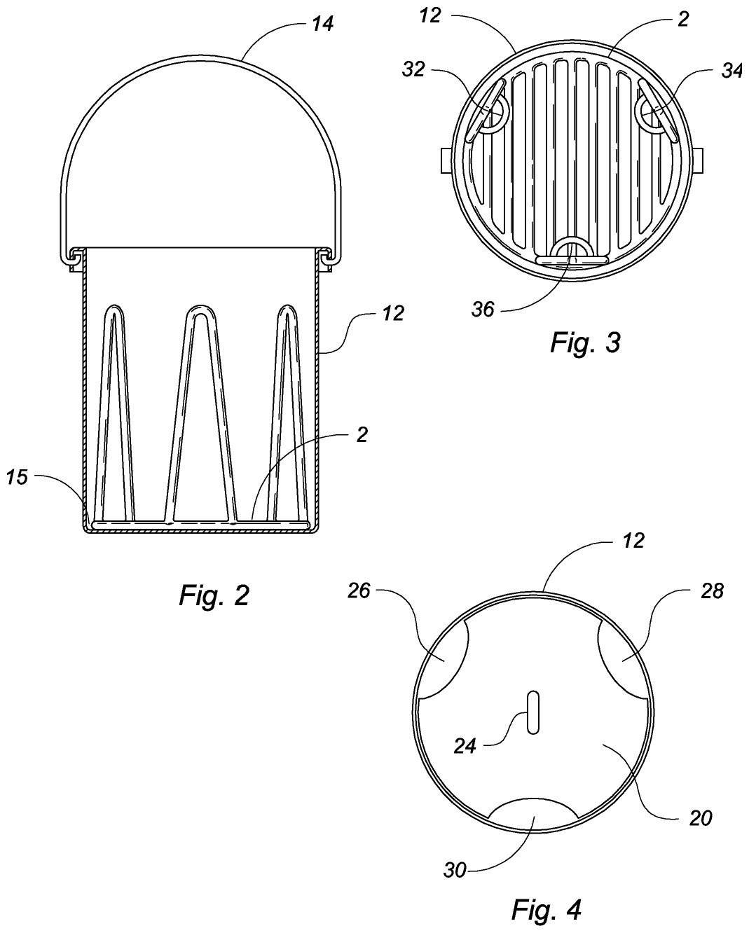

The legs would preferably be between 8 and 14 inches in height, or more preferably between 8 and 12 inches in height. References to the height of the legs refers to the height of the grill above the surface that the legs are resting on when the grill is in use. The legs could be straight or curved, and preferably have minimal angling outward beyond the circumference of the grill 2 (resulting in a grill leg angle greater than 90 degrees). Any such grill leg angle would preferably conform to any gradual increase in the diameter of the container. When not in use, grill 2 is placed inside a container 12 in an inverted position as shown in FIG. 2. With a circular grill the container should also be circular, such as in the shape of a bucket. The container should have a handle, such as a handle 14 shown in FIG. 2. As shown in FIG. 2, the upper surface of the grill 2 would rest at the bottom of container 12 when the grill is inverted in the container.

The grill is preferably constructed of metal, such as round steel as shown in FIG. 1 having a diameter between ⅛ and ⅜ inch. The container and grill are sized so that the grill fits within the container with some gap space between its perimeter and the inside diameter of a container. Gap space 15 is shown in FIG. 2. The gap space should generally be less than 1 inch, and preferably between ⅛ and ½ of an inch (meaning that in the case of a circular grill the diameter of the grill is ¼ to 1 inch less than the inside diameter of the container). The preferred dimensions allow the grill to fit securely, but not tightly, within the container. The container should be sufficiently tall so that the legs of the grill do not protrude above the top of the container.

Between the size or diameter of the grill construction material, and the desired gap space between the grill and the container, the inverted grill still takes up a relatively small portion of the volume of the container. This leaves a substantial portion of the container volume available for storage of other items. For convenience in this description, this available storage space is referred to as the “gear storage cylinder.” The term “gear storage cylinder” refers to the volume of the largest cylinder that fits within the space between the legs of the inverted grills and with the circumference of the cylinder in contact with the legs. In other words, the gear storage cylinder is the cylinder that would snuggly fit inside the grill when it is inverted in the container. Preferably the volume of the gear storage cylinder is at least 50% of the volume of the container, and more preferably at least 75% of the volume of the container.

A beneficial aspect of this invention is the relatively small amount of container volume taken up by the inverted grill. In the example described below, only 3/8 inch of the depth and 1¼ inch of the diameter of the container is taken up by the grill (including its legs and spacing between the legs and the container). Consider a container 12 inches in diameter and 15 inches high, with a grill made of ⅜ inch steel rods and having an outer diameter of 11.5 inches (hence a gap space of ¼ inch), and with three legs made of the same ⅜ inch steel rods. In this example the gear storage cylinder is 10.75 inches in diameter and 14.625 inches high. The volume of the container is 1696 cubic inches and the volume of the gear storage cylinder is 1327 cubic inches. Hence the volume of the gear storage cylinder is 78% of the volume of the container.

As shown in FIG. 3, it is also desirable for one or more of the legs to include a tab 32, 34, and 36 extending inward from the wall of the container, preferably in an arced shape, to allow a user's finger to fit under it to more easily lift the inverted grill out of the container.

FIG. 4 shows an optional protective divider 20 that may be placed on top of the inverted grill to separate it from adjacent items stored in the container. The divider is preferably circular in shape and has a diameter at least 75% of the diameter of the grill to provide a barrier between the grill and any other items that might be carried in the container. Ideally there is between ⅛ and ½ inch gap space between the circumference of the divider in the inside diameter of the container (meaning the diameter of the divider is ¼ to 1 inch less than the inside diameter of the container). As shown in FIG. 4, the divider preferably includes structure 24 to facilitate lifting the divider 20 out of the container 12. The structure could be a low-profile handle or a cord or rope, or a recessed plastic handle, or a small opening through the divider in which a finger may be inserted to lift the divider (but with the opening small enough that little residue from the grill would pass through it). For convenience, the divider and grill may have the same diameter (both slightly less than the container inside dimensions).

The grill 2 should be constructed of iron or steel or another fire-resistant material. The container could be constructed of plastic or metal or other suitable material, with plastic the preferred material because of its lighter weight. The divider could be constructed of plastic, wood, metal or various other materials, with plastic being the preferred material.

In use, a user would lift the divider 20 (if present) out of the container 12 and then lift the inverted grill 2 out of the container. The grill would be positioned over an open fire and used for cooking or grilling. After it is allowed to cool, the grill would be returned to the container in an inverted position and the divider (if utilized) would be placed over it. As shown in the top view of FIG. 4, the divider 20 would have cutouts 26, 28, and 30 to fit over the legs of the inverted grill 2 so that the only portion of the grill protruding above the divider into the open space of the container would be the legs. While the legs may be slightly dirty, they would generally not be as dirty as the grill itself and the fact that they could contact other items in the container would not be a problem. The user could then store additional items in the remaining portion of the container since the only portion taken up by the grill is the portion at the very bottom below the divider and a small area utilized by the legs. This would provide ample space in the container for fire starters, firewood, cooking utensils, etc.

When the grill of this invention is stored upside down in the container of this invention, the combination affords the very desirable attribute of a low center of gravity, making the combination especially stable in a boat or other mode of transportation.

If firewood is stored in the container (with the grill inverted beneath the wood and no divider in use) it is particularly convenient to dump the entire contents of the container on the ground with the grill resting on the firewood ready to be lit.

While this description focuses on a circular grill and a container with a circular cross section, other shapes would be suitable as well. For example the grill could be square, hexagonal, or octagonal, or any other desired shape. In those situations, the container of this invention would preferably have a circular cross section, or could have a cross section conforming to the exact shaper of the grill. In the case of a grill having a shape other than circular, the dimensions disclosed in this invention should be construed to refer to the dimensions of a circle fully enclosing (circumscribing) the grill. For example, in the case of a hexagonal grill, the dimensions referenced would be that of a circle with the hexagon fully inscribed within it. If it is a regular hexagon, each side of the hexagon would equal the radius of said circle. In the case of a container having a cross section shape other than circular, the dimensions disclosed in this invention should be construed to refer to the dimensions of a circle fully enclosing (circumscribing) the container cross section.

In some situations, it is also desirable for the container to have a slightly conical shape—with its diameter increasing as the distance from the bottom of the container increases, hence providing a slightly larger volume than if it were exactly cylindrical. In this embodiment, it would be desirable for the legs of the grill to be slightly skewed outward (with a grill leg angle greater than 90 degrees) to conform to the shape of the conical container when the grill is inverted in the container. This offers the additional advantage of a slightly wider leg configuration with additional stability.

We claim:

1. A combination grill and container for a grill comprising
a grill having a circular shape and having at least three legs and having a diameter, and
a cylindrical container having a bottom with a circular cross section having a diameter,
wherein said container diameter is greater than said grill diameter and said grill may be inverted in said container.

2. The combination of claim 1, wherein said grill diameter is no more than 1 inch less that said container bottom diameter.

3. The combination of claim 1, wherein said grill diameter is no more than ½ inch less that said container bottom diameter.

4. The combination of claim 1, with the said grill diameter and said container bottom diameter each being between 9 and 14 inches.

5. The combination of claim 1, wherein the legs of said grill extending from said grill at a grill leg angle between 90 degrees and 120 degrees.

6. The combination of claim 1, wherein said legs are between 8 and 12 inches in height.

7. The combination of claim 1 wherein said legs are permanently attached to said grill.

8. The combination of claim 1 wherein the volume of the gear storage cylinder filling the space between the legs of the inverted grill has a volume at least 50% of the container volume.

9. The combination of claim 1 wherein the volume of the gear storage cylinder filling the space between the legs of the inverted grill has a volume at least 75% of the container volume.

10. The combination of claim 1 further comprising a divider having a circular shape and a diameter at least 75% of said grill diameter.

11. The combination of claim 1 with at least one leg of said grill having a tab.

12. A combination grill and container for a grill comprising
a grill having a shape that may be circumscribed by a circle having a diameter and having at least three legs, and
a cylindrical container having a bottom with a circular cross section having a diameter,
wherein said container diameter is greater than said grill-circumscribing diameter and said grill may be inverted in said container.

13. The combination of claim 12, wherein said grill circumscribing diameter is no more than 1 inch less that said container bottom diameter.

14. The combination of claim 12, wherein said grill circumscribing diameter is no more than ½ inch less that said container bottom diameter.

15. The combination of claim 12, with the said grill circumscribing diameter and said container bottom diameter each being between 9 and 14 inches.

16. The combination of claim 12, wherein the legs of said grill extending from said grill at a grill leg angle between 90 degrees and 120 degrees.

17. The combination of claim 16, wherein said legs are between 8 and 12 inches in height.

18. The combination grill and container of claim 16 wherein the volume of the gear cylinder filling the space between the legs of the inverted grill has a volume at least 50% of the container volume.

19. The combination grill and container of claim 16 further comprising a divider having a circular shape and a diameter at least 75% of said grill diameter.

20. The combination grill and container of claim 16 with at least one leg of said grill having a tab.
